(19) United States
(12) Patent Application Publication
(10) Pub. No.: US 2011/0238890 A1
(43) Pub. Date: Sep. 29, 2011

(54) MEMORY CONTROLLER, MEMORY SYSTEM, PERSONAL COMPUTER, AND METHOD OF CONTROLLING MEMORY SYSTEM

(75) Inventor: Hiroshi SUKEGAWA, Tokyo (JP)

(73) Assignee: Kabushiki Kaisha Toshiba, Tokyo (JP)

(21) Appl. No.: 12/886,029

(22) Filed: Sep. 20, 2010

(30) Foreign Application Priority Data
Mar. 25, 2010 (JP) 2010-069418

(51) Int. Cl. G06F 12/02; G06F 12/00

(52) U.S. Cl. 711/103; 711/E12.001; 711/E12.008

(57) ABSTRACT

According to one embodiment, a memory controller that performs control of a nonvolatile semiconductor memory includes a first management table that stores correspondence between logical block addresses and physical block addresses, a second management table that stores a number of times of data writing for each of the logical block addresses, and a third management table that stores a number of times of data erasing for each of the physical block addresses. The memory controller according to the embodiment includes a writing control unit that selects a spare block not associated with the logical block address and writes data in the spare block. The writing control unit levels, based on the number of times of data writing associated with the logical block addresses and the number of times of data erasing associated with the physical block addresses, numbers of times of data erasing among the blocks.

### CROSS-REFERENCE TO RELATED APPLICATIONS

This application is based upon and claims the benefit of priority from the prior Japanese Patent Application No. 2010-069418, filed on Mar. 25, 2010; the entire contents of which are incorporated herein by reference.

### FIELD

Embodiments described herein relate generally to a memory controller, a memory system, a personal computer, and a method of controlling the memory system.

### BACKGROUND

The structure of a NAND flash memory is simplified and a reduction in cost and an increase in capacity of the NAND flash memory are realized by collectively erasing data stored in a plurality of memory cells called blocks. The NAND flash memory does not include a movable section and consumes low power. Therefore, the NAND flash memory is widely used as a storage device replacing a HDD and a storage device of a host such as a cellular phone or a portable music player. However, it is known that the NAND flash memory has a limit in the number of times of writing and erasing.

### BRIEF DESCRIPTION OF THE DRAWINGS

FIG. 1 is a block diagram of the configuration of a memory system according to first to third embodiments;

FIG. 2 is a diagram of a relation between physical addresses and logical addresses in a semiconductor storage device according to the first to third embodiments;

FIG. 3 is a diagram of a logical address management table according to the first to third embodiments;

FIG. 4 is a diagram of a spare block management table according to the first to third embodiments;

FIG. 5 is a flowchart for explaining a specific procedure of passive wear leveling performed by a memory controller according to the first embodiment;

FIG. 6 is a diagram of a logical address management table according to the second embodiment;

FIG. 7 is a diagram of a distribution of the number of times of writing for each of logical addresses;

FIG. 8 is a diagram in which FIG. 7 is grouped according to a magnitude relation among the numbers of times of writing;

FIG. 9 is a diagram of a spare block management table according to the second embodiment;

FIG. 10 is a diagram of a distribution of the number of times of block erasing for each of spare blocks;

FIG. 11 is a diagram in which FIG. 10 is grouped according to a magnitude relation among the numbers of times of block erasing;

FIG. 12 is a flowchart for explaining a specific procedure of passive wear leveling performed by a memory controller according to the second embodiment;

FIG. 13 is a flowchart for explaining a specific procedure of active wear leveling performed by a memory controller according to the third embodiment;

FIG. 14 is a perspective view of an entire personal computer mounted with an SSD as a memory system according to a fourth embodiment; and

FIG. 15 is a diagram of a system configuration example of the personal computer mounted with the SSD as the memory system according to the fourth embodiment.

### DETAILED DESCRIPTION

In general, according to one embodiment, a memory controller that performs control of a nonvolatile semiconductor memory including a plurality of blocks, the block being a unit of data erasing, includes: a first management table that stores correspondence between logical block addresses and physical block addresses; a second management table that stores a number of times of data writing for each of the logical block addresses; and a third management table that stores a number of times of data erasing for each of the physical block addresses. The memory controller according to the embodiment includes a writing control unit that selects a spare block not associated with the logical block address and writes data in the spare block. The writing control unit levels, based on the number of times of data writing associated with the logical block addresses and the number of times of data erasing associated with the physical block addresses, numbers of times of data erasing among the blocks.

Limitations are set on the number of times of writing and erasing in memory cells of a NAND flash memory because higher voltage is applied to a gate compared with a substrate and electrons are injected into a floating gate (writing) and higher voltage is applied to the source compared with the gate and the electrons are extracted from the floating gate (erasing). In other words, if writing and erasing processing is executed on a specific memory cell many times, in some case, an oxide film around the floating gate is deteriorated and data is destroyed.

To prevent such writing and erasing processing from being concentrated on the specific memory cell, the memory controller averages the numbers of times of the writing and erasing processing. This is realized by so-called wear leveling in which the memory controller counts the number of times of erasing of physical blocks as units of erasing processing, interchanges physical blocks having large numbers of times of erasing processing and physical blocks having small numbers of times of erasing processing, and averages the numbers of times of writing and erasing processing.

However, in the wear leveling in the past, the memory controller refers to only the numbers of times of erasing and writing as attributes of the physical blocks. For example, the memory controller attempts averaging of the numbers of times of writing by including block interchanging means for interchanging a physical block having the smallest number of times of writing and a physical block that reaches a predetermined number of times of check.

In a semiconductor storage device that performs the wear leveling, in general, a logical address/physical address conversion (hereinafter, “logical to physical conversion”) table for converting a logical address in to a physical address is used. By using this logical to physical conversion table, even when update locations designated by the host using logical addresses are biased, it is possible to disperse physical storage locations on the inside of the semiconductor storage device. In the semiconductor storage device that performs the wear leveling, a correspondence relation between logical addresses and physical addresses changes in this way every time rewriting is performed.

When the correspondence relation between logical addresses and physical addresses changes every time rewriting is performed as in the semiconductor storage device that performs the wear leveling such as a solid state drive (SSD), a bias of frequencies of rewriting as an external request from the host is not an attribute of the physical blocks but is originally an attribute of the logical addresses. However, in the wear leveling in the past, only the numbers of times of writing and erasing as attributes of the physical blocks are referred to. A bias characteristic of the rewriting frequencies as the attributes of the logical addresses is not taken into account at all.

Therefore, in the wear leveling in the past, for example, it is likely that a physical address of a physical block having a small number of times of writing and erasing is allocated to a logical address having a low frequency of rewriting as an external request from the host. In this case, it is less likely that the physical block is updated in a new relation of logical to physical conversion after the allocation. It is highly likely that the number of times of writing and erasing remains small. As a result, averaging of the numbers of times of rewriting of the physical blocks is not appropriately performed.

Exemplary embodiments of a memory controller, a memory system, a personal computer, and a method of controlling the memory system will be explained below in detail with reference to the accompanying drawings. The present invention is not limited to the following embodiments.

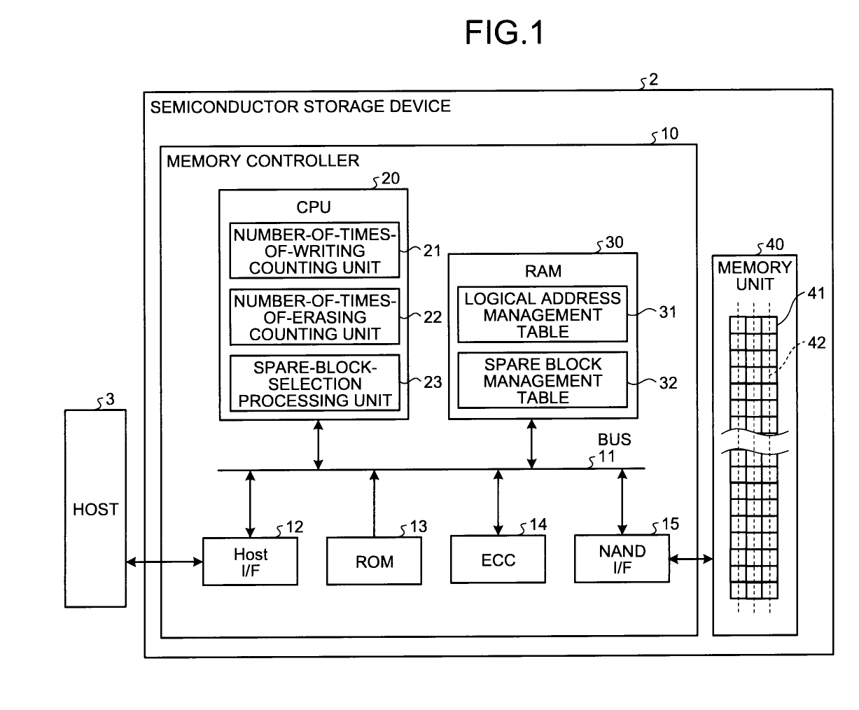

FIG. 1 is a block diagram of the configuration of a semiconductor storage device 2 as a memory system according to a first embodiment of the present invention. The semiconductor storage device 2 is, for example, a memory card detachably connected to a host 3 such as a personal computer or a digital camera or a memory of an embedded type stored on the inside of the host 3 and functioning as an external storage device of the host 3.

The semiconductor storage device 2 includes a nonvolatile semiconductor memory (hereinafter also simply referred to as “memory unit”) 40 and a memory controller 10. The memory unit 40 is, for example, a NAND flash memory and has structure in which a large number of memory cells 41 as unit cells are arranged in a matrix shape at intersections of bit lines (not shown) and word lines 42. Data erasing in the memory unit 40 is performed in a unit of a physical block including a plurality of unit cells. The memory unit 40 includes a plurality of physical blocks. Writing in and readout from the memory unit 40 are performed in physical page units. Because one physical block includes a plurality of physical pages, the size of the physical pages is smaller than the size of the physical block.

The memory controller 10 includes a central processing unit (CPU) 20 as a control unit, a random access memory (RAM) 30, a host interface (I/F) 12, a read only memory (ROM) 13, an error correcting code (ECC) circuit 14 that performs encoding processing for data to be stored and decoding processing for stored data, and a NAND interface (I/F) 15, which are connected via a bus 11.

The memory controller 10 performs data transmission and reception between the host 3 and the RAM 30 via the host I/F 12 and performs data transmission and reception between the memory unit 40 and the RAM 30 via the NAND I/F 15 according to control by the CPU 20. The CPU 20 includes, besides a normal control unit that performs data transmission and reception control between the host 3 and the RAM 30 and data transmission and reception control between the memory unit 40 and the RAM 30, a writing-number-of-times counting unit 21 that counts, for each of logical addresses, the number of times of writing of data in the memory unit 40, a number-of-times-of-erasing counting unit 22 that counts the number of times of data erasing as the number of times of data rewriting for each of physical blocks, which is a unit of data erasing of the memory unit 40, and a spare-block-selection processing unit 23 that performs selection of a spare block, which is a physical block to which a corresponding logical address is not allocated. The spare block (a free block) is a physical block not including valid data therein and not allocated with an application.

When a writing request for data is generated from the host 3, the spare-block-selection processing unit 23 accesses the RAM 30 via the bus 11 and performs, based on management information (e.g., a spare block management table explained later) or the like stored in the RAM 30, selection of a spare block in which data is written.

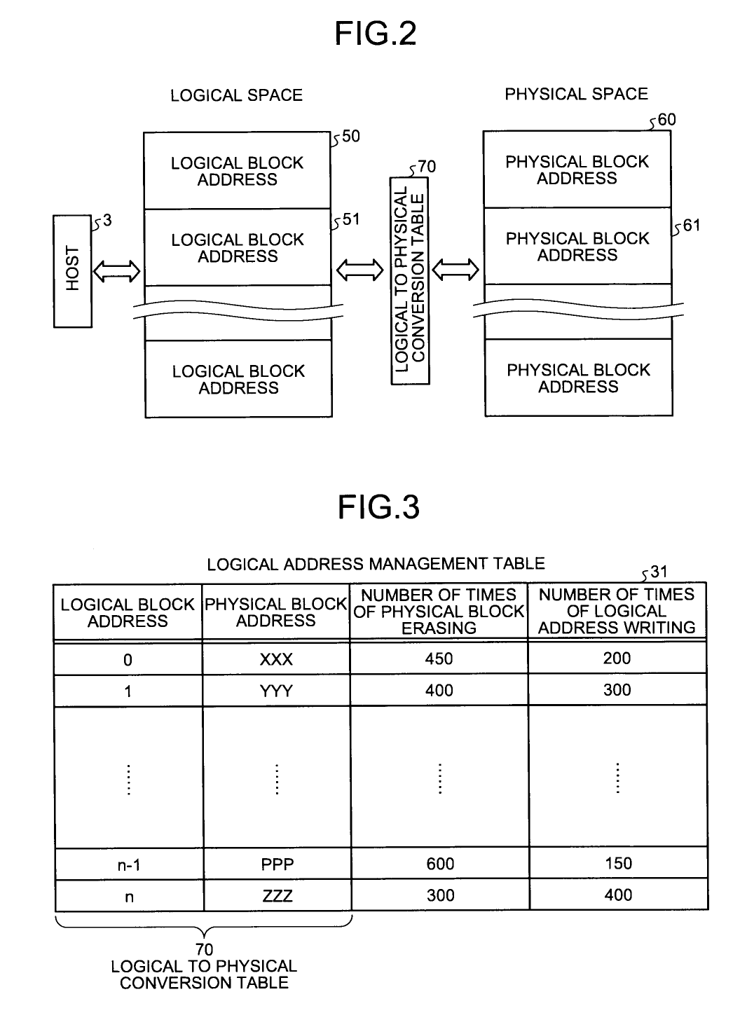

FIG. 2 is a diagram for explaining a concept of logical to physical conversion in this embodiment. Terms for explaining the concept are as explained below. A logical address is an address used by a host, for example, a logical block addressing (LBA). The LBA is a logical address with a serial number starting from 0 allocated to a sector (having size of, for example, 512 bytes). The sector is a unit smaller than a physical page. A physical address is an address indicating a storage position in the memory unit 40.

In this embodiment, as a unit of a logical address having a section size same as the size of a physical block as a unit of data erasing, a logical block address as a higher-order address of the logical address (e.g., LBA) is associated with a physical block address as a physical address of the physical block. As shown in FIG. 2, logical to physical conversion for associating one physical block address to one logical block address is performed. However, logical to physical conversion is not always limited to this logical to physical conversion relation as long as the logical to physical conversion does not depart from the scope of the technical idea included in the gist of this embodiment.

The RAM 30 includes a logical address management table 31 and a spare block management table 32 besides a region functioning as a cache region interposed between the host 3 and the memory unit 40. The logical address management table 31 includes a logical address/physical address conversion table (a logical to physical conversion table) 70 as a first management table for converting a logical block address into a physical block address in the memory unit 40.

As explained above, the spare-block-selection processing unit 23 selects, in response to a writing instruction for data from the host 3, a spare block to which a corresponding logical address is not allocated. Therefore, in this embodiment, a relation of logical to physical conversion changes every time data rewriting is performed. A writing instruction from the host 3 to the memory unit 40 usually includes a starting logical address and data size.

The logical address management table 31 stores the numbers of times of data erasing (the numbers of times of physical block erasing) of physical blocks indicated by physical block addresses registered in the logical to physical conversion table 70 as shown in FIG. 3 and the numbers of times of writing (the numbers of times of logical address writing) instructed from the host 3 for respective logical block addresses.

Therefore, the logical address management table 31 also includes a number-of-times-of-logical-writing table, which is a second management table for storing the number of times of writing from the host 3 for each of the logical block addresses. The number-of-times-of-logical-writing table reflects a bias characteristic of rewriting frequencies as attributes of logical addresses.

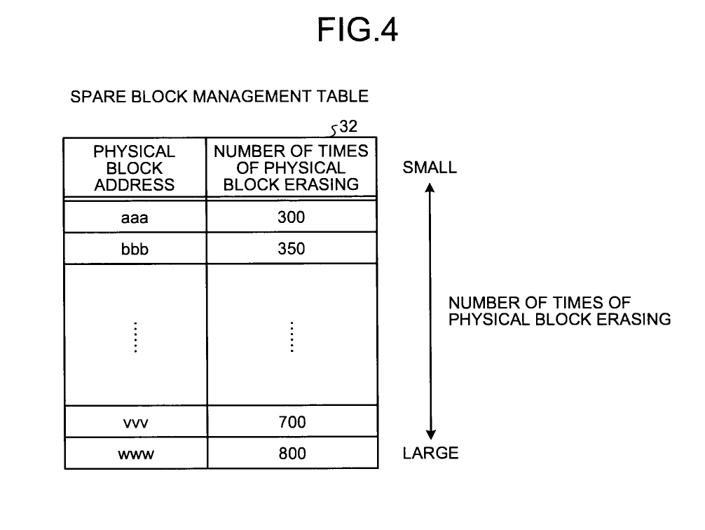

The spare block management table 32 includes, as shown in FIG. 4, physical block addresses of spare blocks, which are physical blocks to which corresponding logical addresses are not allocated, and the numbers of times of data erasing of physical blocks corresponding to the physical block addresses (the numbers of times of physical block erasing). In this table, for example, as shown in FIG. 4, the physical block addresses can be sorted according to magnitudes of the numbers of times of physical block erasing.

Therefore, if information concerning the number of times of data erasing of a physical block for each of the physical block addresses registered in the logical address management table 31 and information concerning the number of times of data erasing of a physical block for each of the physical block addresses registered in the spare block management table 32 are combined, a number-of-times-of-physical-erasing table as a third management table for storing the number of times of data erasing for each of the physical block addresses is formed. The number-of-times-of-physical-erasing table reflects a frequency of the number of times of erasing (and writing) for each of physical blocks, i.e., a physical degree of fatigue of the physical block.

The CPU 20 executes, with firmware (FW), operation of an address conversing unit (not shown) that performs, based on the logical to physical conversion table 70 included in the logical address management table 31, conversion between a logical address and a physical address. Control of the entire semiconductor storage device 2 corresponding to a command input from the host 3 is also executed by the firmware in the CPU 20.

The ROM 13 is a storing unit in which a boot program and the like of the semiconductor storage device 2 are stored. Information for the memory controller 10 to control the semiconductor storage device 2 is also stored in a part of the memory unit 40 or a not-shown nonvolatile storing unit.

In this embodiment, the CPU 20 included in the memory controller 10 increments, when a writing instruction for writing data from the host 3 to an arbitrary logical address is received, the number of times of logical address writing counted for each of the logical block addresses by the number-of-times-of writing counting unit 21. A result of the increment is stored in a space of the number of times of logical address writing of the logical address management table 31 in the RAM 30 via the bus 11.

The CPU 20 also increments, when data is erased in each of the physical blocks of the memory unit 40, the number of times of physical block erasing counted for each of the physical block addresses by the number-of-times-erasing counting unit 22. A result of the increment is stored in, when the physical block has a logical address (i.e., a logical block address) corresponding thereto, a space of the number of times of physical block erasing in a row in which a physical block address of the physical block is registered (i.e., a row in which the logical block address is registered) of the logical address management table 31 in the RAM 30 via the bus 11.

When the physical block in which the data is erased is a spare block, which is a physical block to which a corresponding logical address is not allocated, the result is stored in a space of the number of times of physical block erasing in a row in which the physical block address of the physical block is stored of the spare block management table 32 in the RAM 30.

In the past, wear leveling performed when a writing request is received from the host 3 (hereinafter, “passive wear leveling) is performed without taking into account the number of times of request for writing (rewriting) in the past in a logical address designated in the writing request from the host 3. Specifically, in the passive wear leveling in the past, for example, a spare block having a small number of times of physical block erasing in the spare block management table 32 shown in FIG. 4 is selected depending on only the number of times of erasing of a spare block to perform writing (or block erasing and writing) and a logical address designated from the host 3 is allocated to the physical block.

However, in such a passive wear leveling, it is likely that a purpose of the wear leveling, i.e., averaging of the numbers of times of erasing cannot be appropriately realized. For example, when a rewriting request for a logical address having a small rewriting frequency as an external request from the host 3 is received by chance, it is likely that a physical block having a small number of times of erasing is selected from the spare block to write data in the physical block. In this case, it is highly likely that the physical block still has the small number of times of erasing in a new relation of logical to physical conversion after the logical address allocation. As a result, a bias of the number of times of rewriting of the physical blocks occurs and the averaging is not appropriately performed.

Therefore, in this embodiment, when a writing frequency of a logical address for which a writing (rewriting) instruction is received from the host 3 is small, a spare block having a large number of times of erasing is selected for the logical address to allocate the logical address to the spare block and the data is written in the selected spare block. Conversely, when a writing frequency of a logical address for which a writing instruction is received from the host 3 is large, a spare block having a small number of times of erasing is selected for the logical address to allocate the logical address to the spare block and the data is written in the selected spare block. This makes it possible to solve the problem of the inappropriate averaging.

Specifically, the spare-block-selection processing unit 23 (the writing control unit) selects, in response to a writing request designating a logical block address having a relatively large number of times of writing stored in the logical address management table 31 is designated, a spare block having a relatively small number of times of erasing stored in the spare block management table 32. The spare-block-selection processing unit 23 selects, in response to a writing request designating a logical address having a relatively small number of times of writing, a spare block having a relatively large number of times of erasing.

For example, when a writing request designating a logical block address “n−1” shown in FIG. 3 is received from the host 3, the spare-block-selection processing unit 23 determines that the number of times of logical address writing “150” in the logical address management table 31 is relatively small, selects a spare block in a physical block address “WWW” in FIG. 4 having a relatively large number of times of physical block erasing in the spare block management table 32, and writes data in the spare block. Conversely, when a writing request designating a logical block address “n” shown in FIG. 3 is received, the spare-block-selection processing unit 23 determines that the number of times of logical address writing “400” in the logical address management table 31 is relatively large, selects a spare block in a physical block address “aaa” shown in FIG. 4 having a relatively small number of times of physical block erasing in the spare block management table 32, and writes data in the spare block.

More specifically, logical block addresses sorted according to a magnitude relation of the numbers of times of logical address writing of the logical address management table 31 shown in FIG. 3 and physical block addresses of spare blocks sorted according to a magnitude relation of the numbers of times of physical block erasing of the spare block management table 32 shown in FIG. 4 can also be associated such that the magnitude relations are opposite.

As a method of associating the magnitude relations in opposite order, raw values of the numbers of times do not have to be used. For example, a space of “relative value of the number of times of writing” is further provided in the logical address management table 31 shown in FIG. 3 and a value (0 to 1) obtained by dividing each number of times of logical address writing by a maximum of the numbers of times of logical address writing at that point is stored for each of the logical block addresses. Further, a space of “relative value of the number of times of erasing” is also provided in the spare block management table 32 and a value (0 to 1) obtained by dividing each number of times of physical block erasing by a maximum of the numbers of times of physical block erasing in a spare block at that point is stored for each of the spare blocks.

In response to a writing request designating a logical block address from the host 3, when the “relative value of the number of times of writing” of the logical block address shown in FIG. 3 is X, a “suitable relative value of the number of times of erasing” Y is calculated according to the following Formula 1:

Y=1−X (Formula I)

The spare-block-selection processing unit 23 selects a spare block having a “relative value of the number of times of erasing” closest to calculated Y from the spare block management table 32 and writes data in the spare block.

For example, in response to a writing request designating a logical block address having a relatively small number of times of writing such as the “relative value of the number of times of writing” X=0.2, the spare-block-selection processing unit 23 selects a spare block having a relatively large number of erasing closest to the “suitable relative value of the number of times of erasing” Y=0.8 among the spare blocks.

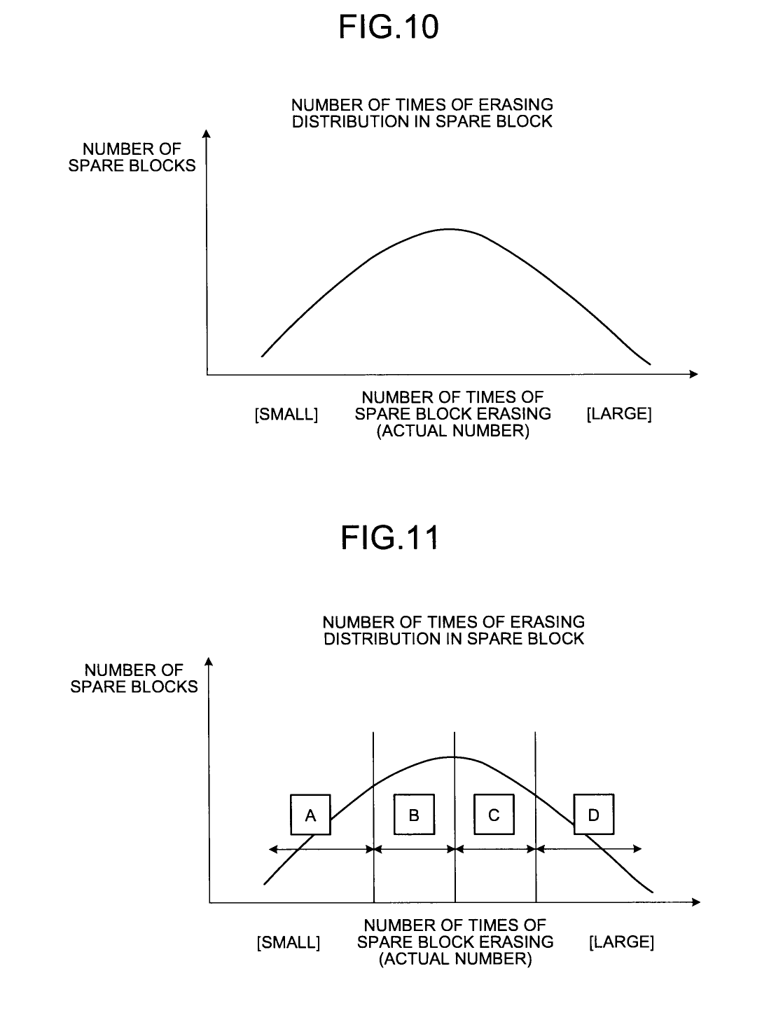

A formula for calculating the “suitable relative value of the number of times of erasing” Y is not limited to the Formula I as long as X and Y have a relation of opposite order. The association can also be more equalized by using a nonlinear formula reflecting a bias of a frequency of the number of times of writing for each of the logical addresses from the host 3 shown in FIG. 7 and a bias of a frequency of the number of times of block erasing for each of the spare blocks shown in FIG. 10.

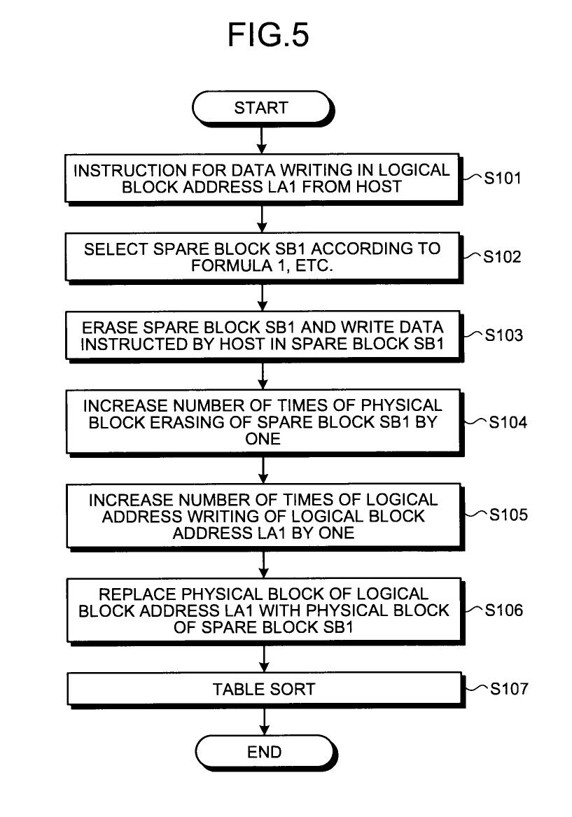

A specific procedure of the passive wear leveling performed by the memory controller 10 according to this embodiment is explained with reference to a flowchart of FIG. 5.

Step S101: Data Writing Instruction

The host 3 sends a data writing request designating, for example, a logical block address LA1 to the memory controller 10.

Step S102: Selection of a Spare Block

The spare-block-selection processing unit 23 selects, with respect to the designated logical block address LA1, a spare block SB1 based on Formula 1.

Step S103: Block Erasing and Writing of Data

A physical block in a physical block address in the memory unit 40 corresponding to the spare block SB1 selected at step S102 is erased. Data instructed by the host 3 is written in the physical block.

Step S104: Increment of the Number of Times of Physical Block Erasing

The number-of-times-of-erasing counting unit 22 in the CPU 20 counts the block erasing at step S103 for each of the physical block addresses. The number-of-times-of-erasing counting unit 22 increases the number of times of physical block erasing in the physical block address of the spare block management table 32 shown in FIG. 4 by one.

Step S105: Increment of the Number of Times of Logical Address Writing

The number-of-times-of-writing counting unit 21 in the CPU 20 counts the instruction for writing in the logical block addresses from the host 3 for each of the logical block addresses. The number-of-times-of-writing counting unit 21 increases the number of times of physical block writing in the logical block address LA1 of the logical address management table 31 shown in FIG. 3 by one.

Step S106: Replacement of Physical Blocks

The physical block address and the number of times of physical block erasing of the logical block address LA1 of the logical address management table 31 are replaced with the physical block address and the number of times of physical block erasing described in the spare block management table 32 of the spare block SB1 selected at step S102. In the replacement, for example, a predetermined storage region (not shown) in the RAM 30 can also be used as a temporary storage region. Consequently, the physical blocks entered in the logical address management table 31 are replaced with the physical blocks entered in the spare block management table 32. After the replacement, the spare block management table 32 is sorted according to the magnitudes of the numbers of times of physical block erasing (the numbers of times of data erasing).

Step S107: Table Sort

The spare block management table 32 is sorted according to the magnitude relation of the numbers of times of physical block erasing (the numbers of times of data erasing).

Every time the memory controller 10 sends an instruction for data writing in an arbitrary logical address to the host 3, the memory controller 10 repeats steps S101 to S107.

As explained above, in this embodiment, when a writing frequency of a logical address for which a writing instruction of data is received from the host 3 is small, a spare block having a large number of times of erasing is dared to be selected and the data is written in the spare block. When a writing frequency of a logical address for which a writing instruction is received from the host 3 is large, a spare block having a small number of times of erasing is selected and the data is written in the spare block.

As explained above, the semiconductor storage device 2 according to this embodiment performs, when a relation of logical to physical conversion changes every time data rewriting is performed, averaging of the numbers of times of rewriting of the physical blocks referring to the numbers of times of rewriting, which are attributes of the logical addresses, i.e., rewriting frequencies of the logical addresses.

In this embodiment, in the passive wear leveling, a physical (spare) block having a large number of times of erasing and a large physical degree of fatigue is allocated to a logical block address having a small writing frequency. Conversely, a physical (spare) block having a small number of times of erasing and a small physical degree of fatigue is allocated to a logical block address having a large writing frequency. This is considered to make it possible to improve accuracy of averaging of the numbers of times of rewriting of the physical blocks.

In other words, it is possible to prevent a phenomenon in the passive wear leveling in the past in which a physical block having a small number of times of writing and erasing is selected as a spare block for the logical address having a small rewriting frequency. Therefore, it is possible to realize, with higher accuracy, the purpose of the wear leveling, i.e., the averaging of the numbers of times of rewriting of the physical blocks and extend the life of a memory system compared with that in the past.

On the other hand, there is a method of wear leveling in which, even when no data rewriting instruction is received from a host, a memory system voluntarily transfers data written in a physical block having a small number of times of erasing to a spare block having a large number of times of erasing to thereby use the physical block having a small number of times of erasing as a spare block (hereinafter, “active wear leveling).

In the embodiment, it is considered that the accuracy of the averaging of the numbers of times of physical block erasing of the passive wear leveling is improved, whereby a necessary number of times of the active wear leveling is reduced. Therefore, it is also possible to reduce the number of times of physical block erasing involved in the voluntary data rewriting of the memory system in the active wear leveling. Consequently, the extension of the life of the memory system through the reduction in the number of times of erasing can also be expected.

A block diagram of the configuration of the semiconductor storage device 2 as a memory system according to a second embodiment of the present invention is the same as FIG. 1. Explanation of the same components is omitted. In this embodiment, as shown in FIG. 2 as an example, logical to physical conversion in which one physical block address, i.e., one physical block of the memory unit 40 is associated with one logical block address is performed. However, logical to physical conversion is not always limited to this logical to physical conversion relation as long as the logical to physical conversion does not depart from the scope of the technical idea included in the gist of this embodiment.

A spare block (to which a logical address is not allocated) is selected in response to an instruction for writing data in an arbitrary logical address from the host 3, the data is written in the spare block, and the spare block is associated with the logical address. In other words, as in the first embodiment, the relation of logical to physical conversion changes every time data is rewritten.

In this embodiment, processing by the spare-block-selection processing unit 23 and the structures of the logical address management table 31 and the spare block management table 32 included in the RAM 30 are different from those in the first embodiment.

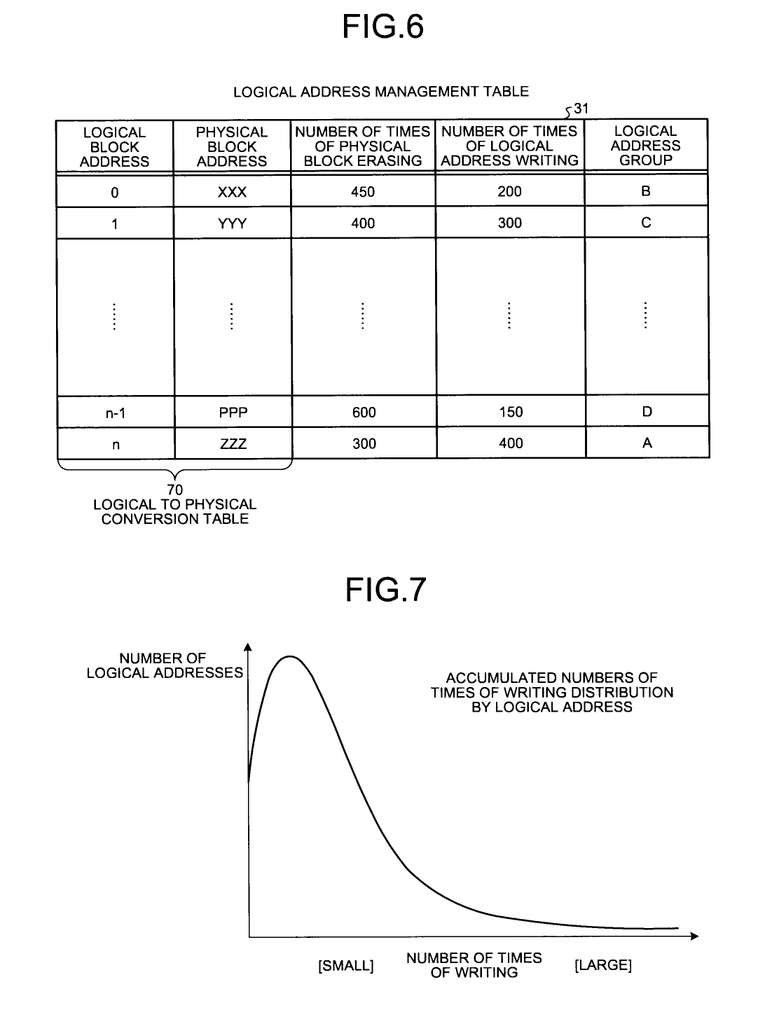

As in the first embodiment, the logical address management table 31 in this embodiment shown in FIG. 6 includes the logical address/physical address conversion table (the logical to physical conversion table) 70 for converting a logical block address into a physical block address, which is a physical address in the memory unit 40 of a physical block corresponding to the logical block address. As in the first embodiment, the logical address management table 31 stores the numbers of times of data erasing of the physical block addresses (the numbers of times of physical block erasing) described in the logical to physical conversion table 70, stores the number of times of writing for each of the logical block addresses (the number of times of logical address writing), and includes a number-of-times-of-logical-writing table.

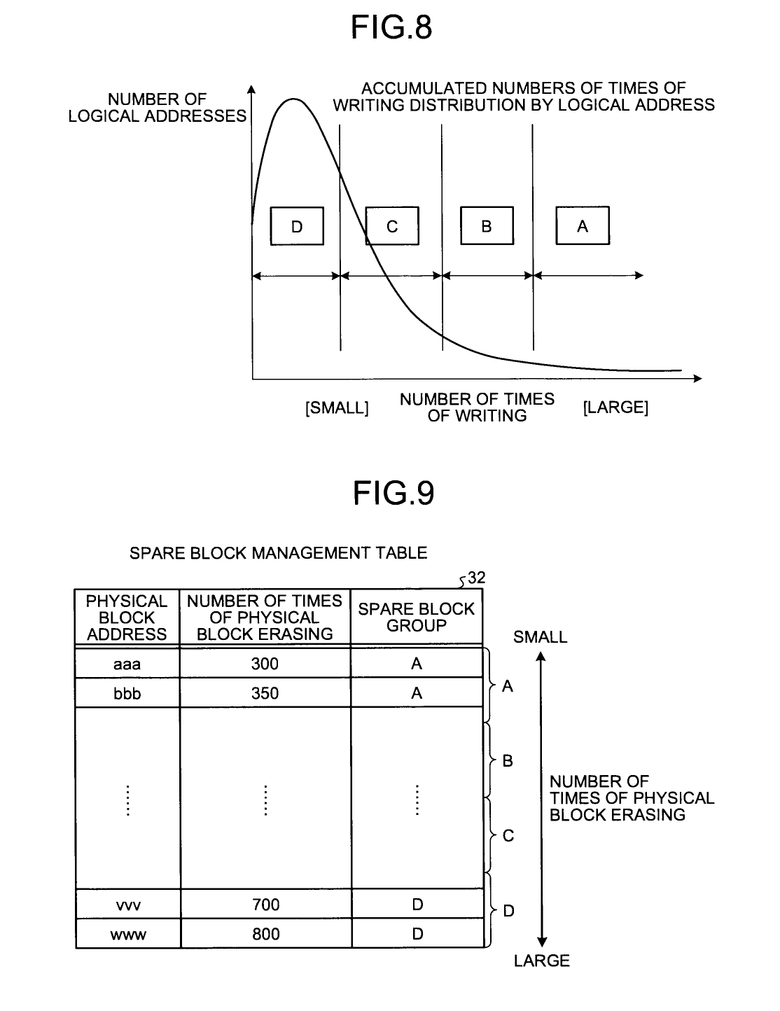

However, as shown in FIG. 6, in the logical address management table 31 in this embodiment, an index of a logical address group is further stored for each of the logical block addresses. In general, as shown in FIG. 7, a bias is present in a frequency of the number of times of writing for each of the logical addresses from the host 3. Therefore, it is possible to classify, based on a magnitude relation of the numbers of times of logical address writing shown in FIG. 6, all the logical block addresses into any one of a plurality of logical address groups. For example, it is possible to classify the logical block addresses into four logical address groups respectively having indexes A to D as shown in FIG. 8.

Specifically, for example, ratios (0 to 1) of the numbers of times of logical block address writing with respect to a maximum of the numbers of times of logical address writing in all the logical block addresses shown in FIG. 6 can be classified into four according to a magnitude relation with three thresholds, for example, 0.25, 0.5, and 0.75. The logical block addresses can be classified into four logical address groups respectively having the indexes A to D in order from the one having the largest ratio as shown in FIG. 8.

The number of logical address groups only has to be plural and is not limited to four. All the logical block addresses can also be classified into a plurality of logical address groups, each having the same number of logical block addresses, based on a magnitude relation of the numbers of times of logical address writing. The classification including intervals of thresholds is not limited to the classification method explained above as long as the classification is based on the magnitude relation of the numbers of times of logical address writing. The indexes set in this way are stored, for each of the logical block addresses, in a space of a logical address group of the logical address management table 31 shown in FIG. 6 as attributes of the logical block addresses.

On the other hand, as in the first embodiment, the spare block management table 32 in this embodiment stores physical block addresses of spare blocks as physical blocks to which corresponding logical addresses are not allocated and the numbers of times of physical block erasing (the numbers of times of data erasing) of physical blocks corresponding to the physical block addresses. The physical block addresses are sorted according to the magnitudes of the numbers of times of physical block erasing.

However, as shown in FIG. 9, in the spare block management table 32 in this embodiment, an index of a spare block group is further stored for each of the physical block addresses of the spare blocks.

In general, as shown in FIG. 10, a bias is present in a frequency of the number of times of block erasing for each of the spare blocks. Therefore, it is possible to classify, based on a magnitude relation of the numbers of times of physical block erasing shown in FIG. 9, all the spare blocks into, for example, any one of spare block groups in a number same as the number of logical address groups. For example, it is possible to classify the spare blocks into four spare block groups respectively having indexes A to D as shown in FIG. 11.

Specifically, for example, ratios (0 to 1) of the numbers of times of physical block erasing with respect to a maximum of the numbers of times of physical block erasing for all the spare blocks shown in FIG. 9 can be classified into four according to a magnitude relation with three thresholds, for example, 0.25, 0.5, and 0.75. The spare blocks can be classified into spare block groups respectively having the indexes A to D in order from the one having the smallest ratio as shown in FIG. 11.

The number of spare block groups only has to be the same as the number of logical address groups and is not limited to four. All the spare blocks can also be classified into a plurality of spare block groups, each having the same number of spare blocks, based on a magnitude relation of the numbers of times of physical block erasing. The classification including intervals of thresholds is not limited to the classification method explained above as long as the classification is based on the magnitude relation of the numbers of times of physical block erasing. The indexes are stored, for each of the physical block addresses of the spare blocks, in a space of a spare block group of the spare block management table 32 shown in FIG. 9.

In this embodiment, when a logical block address for which a writing (rewriting) instruction for data is received from the host 3 belongs to a logical address group having a small writing frequency, a spare block belonging to a spare block group having a high frequency of the number of times of erasing is selected for the logical block address, the logical block address is allocated to the spare block, and the data is written in a physical block in the memory unit 40 corresponding to the selected spare block.

Conversely, when a logical block address for which a writing instruction is received from the host 3 belongs to a logical address group having a large writing frequency, a spare block belonging to a spare block group having a low frequency of the number of times of erasing is selected for the logical block address, the logical block address is allocated to the spare block, and the data is written in a physical block in the memory unit 40 corresponding to the selected spare block.

In the case of the example shown in FIGS. 8 and 11, the spare block groups of the same indexes are combined with the logical address groups, i.e., the spare block groups of the A, B, C, and D indexes are combined with the logical address groups of the same indexes such that a magnitude relation of the numbers of times of logical address writing and a magnitude relation of the numbers of times of physical block erasing are opposite. In the combinations, a spare block is selected for a logical address for which a writing instruction is received.

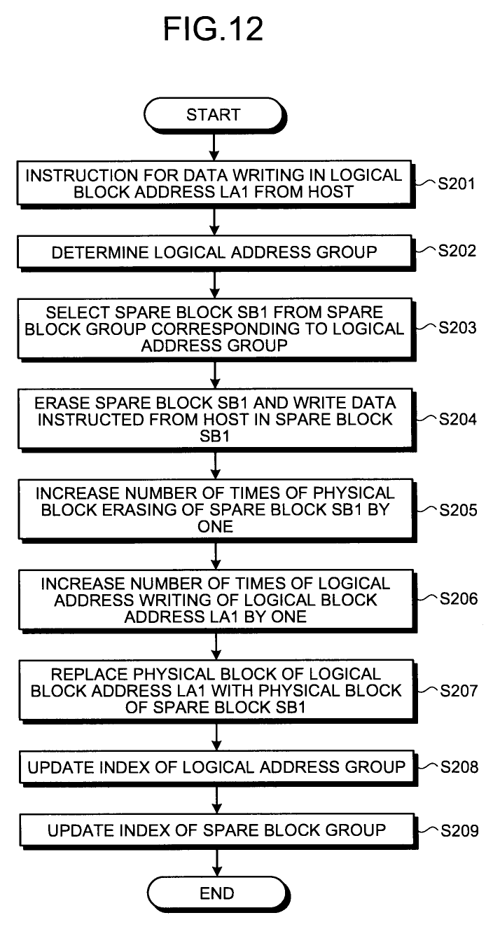

A specific procedure of the passive wear leveling performed by the memory controller 10 according to this embodiment is explained below with reference to a flowchart of FIG. 12.

Step S201: Data Writing Instruction

The host 3 sends a data writing request designating, for example, the logical block address LA1 to the memory controller 10.

Step S202: Determination of a Logical Address Group

The spare-block-selection processing unit 23 accesses the logical address management table 31 shown in FIG. 6 and determines a logical address group based on an index of a logical address group of the logical block address LA1.

Step S203: Selection of a Spare Block

The spare-block-selection processing unit 23 accesses the spare block management table 32 shown in FIG. 9 and selects the spare block SB1 belonging to a spare block group of the same index as the logical address group determined at step S202.

As explained above, the spare block groups are associated with the respective logical address groups such that a magnitude relation of the numbers of times of logical address writing and a magnitude relation of the numbers of times of physical block erasing are opposite. Therefore, any spare block belonging to a spare block group corresponding to the logical address group determined at step S202 can be selected as long as the spare block belong to the spare block group.

However, the averaging of the numbers of times of physical block erasing can be more effectively performed if, by reflecting the idea of the first embodiment, the spare block SB1 is selected out of the spare block group of the same index according to a relative degree of magnitude of the number of times of logical address writing of the logical block address LA1 in the logical address group determined at step S202. Specifically, when the number of times of logical address writing of the logical address LA1 in the logical address group determined at step S202 is relatively large, a spare block having a relatively small number of times of physical block erasing among spare blocks belonging to a spare block group corresponding to the logical address group can also be selected. Conversely, when the number of times of logical address writing is relatively large, a spare block having a relatively small number of times of physical block erasing can also be selected.

Such a mechanism can be realized if, for example, Formula I explained in the first embodiment is used. In this case, in the space of the logical address group of the logical address management table 31 shown in FIG. 6, in addition to the index of the logical address group, a “relative value of the number of times of writing” for each of the logical address groups, which is a value obtained by dividing the number of times of logical address writing in a row of the logical address group by a maximum of the number of times of writing in the logical address group of the index, is further stored. For example, the relative value of the number of times of writing is “A: 0.3”. Similarly, in the space of the spare block group of the spare block management table 32 shown in FIG. 9, a “relative value of the number of times of erasing” for each of the spare block groups such as “D: 0.4”, which is a value obtained by dividing the number of times of physical block erasing in a row of the spare block group by a maximum of the number of times of erasing in each of the spare block groups. After a spare block group of the same index as the logical address group determined at step S202 is selected, the spare block group SB1 closest to a “suitable relative value of the number of times of erasing” is selected out of the spare block group according to Formula I or the like.

Step S204: Block Erasing and Writing of Data

A physical block in a physical block address in the memory unit 40 corresponding to the spare block SB1 selected at step S203 is erased. Data instructed by the host 3 is written in the physical block.

Step S205: Increment of the Number of Times of Physical Block Erasing

The number-of-times-of-erasing counting unit 22 in the CPU 20 counts the block erasing at step S204 for each of the physical block addresses. The number-of-times-of-erasing counting unit 22 increases the number of times of physical block erasing in the physical block address of the spare block management table 32 shown in FIG. 9 by one.

Step S206: Increment of the Number of Times of Logical Address Writing

The number-of-times-of-writing counting unit 21 in the CPU 20 counts the instruction for writing in the logical block addresses from the host 3 for each of the logical block addresses. The number-of-times-of-writing counting unit 21 increases the number of times of physical block writing in the logical block address LA1 of the logical address management table 31 shown in FIG. 6 by one.

Step S207: Replacement of Physical Blocks

The physical block address and the number of times of physical block erasing of the logical block address LA1 of the logical address management table 31 are replaced with the physical block address and the number of times of physical block erasing described in the spare block management table 32 of the spare block SB1 selected at step S203. In the replacement, for example, a predetermined storage region (not shown) in the RAM 30 can also be used as a temporary storage region. Consequently, the physical blocks entered in the logical address management table 31 are replaced with the physical blocks entered in the spare block management table 32. After the replacement, the spare block management table 32 is sorted according to the magnitudes of the numbers of times of physical block erasing (the numbers of times of data erasing).

Step S208: Update of an Index of the Logical Address Group

Because the number of times of logical address writing in the logical address management table 31 is incremented at step S206, in some case, it is necessary to update an index of a logical address group. Specifically, ratios (0 to 1) of a maximum of the numbers of times of logical address writing in all the logical block addresses and the numbers of times of logical address writing are calculated.

The ratios are classified into the four indexes A, B, C, and D again according to, for example three thresholds 0.25, 0.5, and 0.75. When there is a logical block address having an index different from the previous index, the space of the logical address group of the logical block address in FIG. 6 is updated to the index.

Step S209: Update of an Index of a Spare Block Group

Because the physical block addresses and the numbers of times of physical block erasing described in the spare block management table 32 are rewritten and the spare block management table 32 is sorted according to the magnitudes of the numbers of times of physical block erasing, it is necessary to update an index of a spare block group. Specifically, ratios (0 to 1) of a maximum of the numbers of times of physical block erasing of all the spare blocks and the numbers of times of physical block erasing are calculated. The ratios are classified into the four indexes A, B, C, and D again according to, for example three thresholds 0.25, 0.5, and 0.75. Spaces of spare block groups of all the physical block addresses of the spare block management table 32 are updated to the indexes.

Every time the host 3 sends an instruction for data writing in an arbitrary logical address to the memory controller 10, the memory controller 10 repeats steps S201 to S209.

As explained above, in this embodiment, in the memory system in which a relation of logical to physical conversion changes every time data rewriting is performed, frequencies of the number of times of writing are counted as attributes of the logical block addresses, the logical block addresses are classified into groups according to a relative magnitude relation of the frequencies, and the physical blocks included in the spare blocks are also classified into groups according to a relative magnitude relation of the numbers of times of erasing.

During data rewriting in which a relation of logical to physical conversion changes, a logical address group having a low frequency of the number of times of writing is combined with a spare block group having a large number of times of erasing. A logical address group having a high frequency of the number of times of writing is combined with a spare block group having a small number of times of erasing. In the combinations, a spare block is selected for a logical address for which rewriting is requested.

Consequently, it is possible to prevent the phenomenon in the passive wear leveling in the past in which a physical block having a small number of times of writing and erasing is selected as a spare block for the logical address having a small rewriting frequency. Therefore, it is possible to realize, with higher accuracy, the purpose of the wear leveling, i.e., the averaging of the numbers of times of rewriting of the physical blocks and extend the life of a memory system compared with that in the past. Further, as in the first embodiment, the extension of the life of the memory system through the reduction in a necessary number of times the active wear leveling can also be expected.

In this embodiment, the number of spare block groups is explained as the same as the number of logical address groups. However, the number of spare block groups does not always have to be the same as the number of logical address groups as long as it is possible to realize the purpose of obtaining a combination of groups in which a magnitude relation of the numbers of times of writing as attributes of the logical addresses and a magnitude relation of the numbers of times of erasing of spare blocks are opposite.

A simpler example of realization of this embodiment can also be as explained below. Ratios of the number of times of writing in the logical block addresses to a maximum of the numbers of times of logical address writing are classified into logical address groups A, B, and C in order from the one having the largest ratio according to, for example, a magnitude relation of thresholds 0.1 and 0.9. Ratios of the numbers of times of physical block erasing to a maximum of the numbers of times of physical block erasing for all the spare blocks are also classified into spare block groups A, B, and C in order from the one having the smallest ratio according to, for example, the magnitude relation of the thresholds 0.1 and 0.9. Groups of the same indexes are associated with each other.

A block diagram of the configuration of a memory system according to a third embodiment of the present invention is the same as FIG. 1. However, this embodiment relates to the active wear leveling. The RAM 30 includes the logical address management table 31 shown in FIG. 3 and the spare block management table 32 shown in FIG. 4. Explanation of operations of the components common to those in the first embodiment is omitted.

In this embodiment, as in the embodiments explained above, as shown in FIG. 2 as an example, logical to physical conversion in which one physical block address, i.e., one physical block of the memory unit 40 is associated with one logical block address is performed. However, logical to physical conversion is not always limited to this logical to physical conversion relation as long as the logical to physical conversion does not depart from the scope of the technical idea included in the gist of this embodiment. A spare block (not having a logical address) is selected in response to an instruction for writing data in an arbitrary logical address from the host 3, the data is written in the spare block, and the spare block is associated with the logical address. In other words, as in the first and second embodiments, the relation of logical to physical conversion changes every time data is rewritten.

In this embodiment, in the active wear leveling as control for averaging of the numbers of times of rewriting of physical blocks performed when no rewriting instruction is received from the host 3, a physical block having a small number of times of rewriting and a small number of times of writing in a logical block address is replaced with a spare block having a high degree of fatigue. However, the active wear leveling is not executed for a physical block having a small number of times of rewriting but having a large number of times of writing in a logical block address. This makes it possible to improve the accuracy of the averaging of the numbers of times of rewriting of physical blocks compared with that in the past.

In the active wear leveling, a frequency of rewriting of a logical block address of a physical block in which valid data is written is taken into account. Specifically, the memory controller 10 performs the active wear leveling taking into account the numbers of times of logical address writing of the logical address management table 31 shown in FIG. 3.

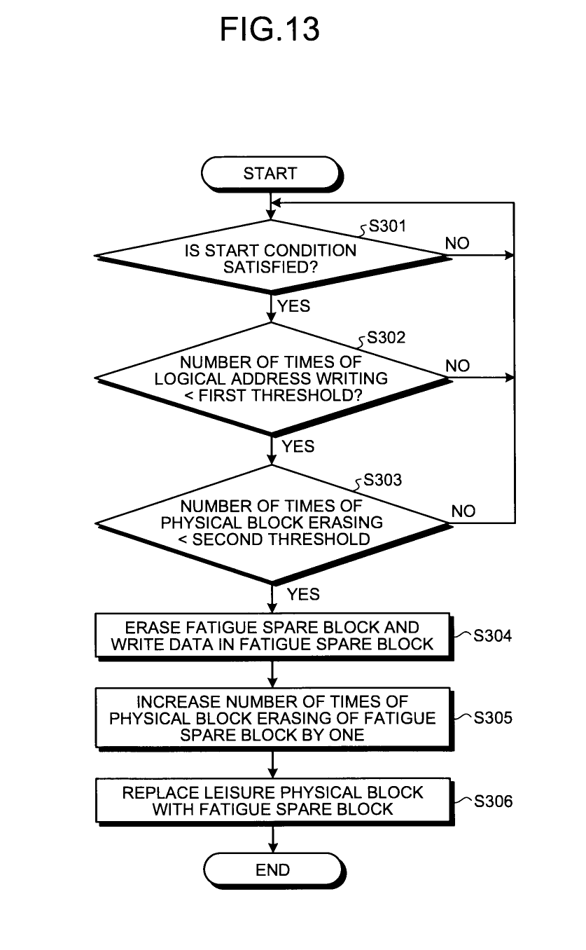

A specific procedure of the active wear leveling performed by the memory controller 10 according to this embodiment is explained with reference to a flowchart of FIG. 13.

Step S301: Determination of a Start Condition

When no instruction for writing of data in a logical address is received from the host 3, the CPU 20 checks the numbers of times of physical block erasing of the logical address management table 31 and the numbers of times of physical block erasing of the spare block management table 32 in the RAM 30. For example, when a difference between a maximum and a minimum of the numbers of times of erasing is equal to or larger than a predetermined threshold in all the physical blocks, the CPU 20 determines, as a start condition, whether imbalance of the numbers of times of physical block erasing exceeds a predetermined condition. The CPU 20 can also periodically start the active wear leveling or determine a start condition at every fixed time. When the start condition is satisfied, the CPU 20 proceeds to step S302. When the start condition is not satisfied, the CPU 20 repeats step S301.

Step S302: A Threshold Decision of the Number of Times of Logical Address Writing

The CPU 20 accesses the logical address management table 31 in the RAM 30 and determines whether, among the numbers of times of logical address writing of the logical address management table 31, there are the numbers of times of logical address wiring that satisfy a condition that the number of times of logical address writing is smaller than a first threshold. The first threshold only has to be stored in the RAM 30 or the like. A value of the first threshold can be, for example, a value obtained by multiplying a maximum of the numbers of times of logical address writing in all the logical block addresses shown in FIG. 3 with a coefficient such as 0.1 to 0.3 such that a logical block having a relative small number of times of logical address writing can be selected.

However, the purpose of the first threshold is to select logical block addresses for which it is predicted that few writing request is received from the host 3 in future. Therefore, the first threshold is not limited by the example and the coefficient explained above and can also be, for example, a specific numerical value of the number of times of writing rather than a relative value.

When there is no logical block address that satisfies the condition, the CPU 20 returns to step S301. When there are logical block addresses that satisfy the condition, the CPU 20 proceeds to step S303.

Step S303: A Threshold Decision of the Number of Times of Physical Block Erasing

The CPU 20 determines whether, among the numbers of times of physical block erasing in rows of the logical block addresses that satisfy the condition at step S302, there is the number of times of physical block erasing that satisfies a condition that the number of times of physical block erasing is smaller than a second threshold in the logical address management table 31 in the RAM 30. The second threshold only has to be stored in the RAM 30 or the like. As a value of the second threshold, for example, a value obtained by multiplying a maximum of the numbers of times of physical block erasing for all the logical block addresses shown in FIG. 3 with a coefficient such as 0.1 to 0.3 only has to be selected. The value makes it possible to further select a physical block having a small number of times of physical block erasing out of physical blocks in which valid data is written.

The purpose of the second threshold is to select a physical block having a smaller physical degree of fatigue out of physical blocks corresponding to the logical block addresses that satisfies the condition at step S302. Therefore, the second threshold is not limited by the example and the coefficient explained above and can also be, for example, a specific number of times of physical block erasing. When there is no physical block that satisfies the condition, the CPU 20 returns to step S301. When there is a physical block that satisfies the condition, the CPU 20 sets the physical block as a leisure physical block and sets a logical block address corresponding to the leisure physical block as a leisure logical address. The CPU 20 proceeds to step S304.

Step S304: Block Erasing and Writing of Data in a Fatigue Spare Block

The spare-block-selection processing unit 23 selects, among the spare blocks in the spare block management table 32 shown in FIG. 4, a fatigue spare block in which the number of times of physical block erasing is larger than a third threshold or is a maximum. After erasing the fatigue spare block, the spare-block-selection processing unit 23 writes data written in the leisure physical block in the fatigue spare block.

As a condition for the third threshold, the third threshold is basically larger than the second threshold. However, a constant can also be selected if a physical absolute degree of fatigue of a physical block is set as a reference. However, a relative value can also be selected such as a value obtained by multiplying a maximum of the numbers of times of physical block erasing for all the spare blocks shown in FIG. 4 with a coefficient such as 0.9. If a spare block having a high degree of fatigue can be selected, the third threshold is not limited to the example and the coefficient explained above.

If there is one leisure physical block that satisfies the condition at step S303, a fatigue spare block in which the number of times of physical block erasing takes a maximum in the spare block management table 32 can also be selected. When there are a plurality of leisure physical blocks, the active wear leveling is more effective if the leisure physical blocks are selected in an opposite order such that data of a leisure physical block having a smaller number of times of logical address writing corresponding thereto is written in a fatigue spare block having a larger number of times of physical block erasing.

If a spare block having the number of times of physical block erasing larger than the second threshold is selected as a fatigue spare block and the data written in the leisure physical block is written in the fatigue spare block, the active wear leveling is realized. Therefore, the fatigue spare block does not always have to be selected taking into account the third threshold. Subsequently, the CPU 20 proceeds to step S305.

Step S305: Increment of the Number of Times of Erasing Of the Fatigue Spare Block

The number-of-times-of-erasing counting unit 22 in the CPU 20 counts the block erasing at step S304 for each of the physical block addresses and increases the number of times of physical block erasing of the physical block address of the spare block management table 32 shown in FIG. 4 by one.

Step S306: Replacement of the Leisure Physical Block With the Fatigue Spare Block

The spare-block-selection processing unit 23 replaces the physical block address and the number of times of physical block erasing of the leisure physical block of the logical address management table 31 with the physical block address and the number of times of physical block erasing of the fatigue spare block in which the data written in the leisure physical block is written at step S304. In the replacement, for example, a predetermined storage region (not shown) in the RAM 30 can also be used as a temporary storage region.

Consequently, the physical block address of the leisure physical block is erased from the logical address management table 31 and entered in the spare block management table 32 anew. The leisure physical block becomes a spare block anew. After the replacement, the spare block management table 32 is sorted according to the magnitudes of the numbers of times of physical block erasing (the numbers of times of data erasing).

When the host 3 does not send a data writing instruction to the memory controller 10, the memory controller 10 performs steps S301 to S306.

As explained above, in this embodiment, in the active wear leveling performed when no rewriting instruction is received from the host 3, only a physical block in a logical block address having a low frequency of a writing request from the host 3 is replaced with a spare block having a high degree of fatigue when the number of times of erasing of the physical block is small. This makes it possible to prevent the active wear leveling in the past in which a physical block in a logical block address having a high frequency of a writing request from the host 3 is also replaced with a spare block having a high degree of fatigue based on a condition that the number of times of erasing of the physical block is small.

Specifically, a logical address having a high frequency of data rewriting other than the leisure logical address is not set as a target of the active wear leveling even if the number of times of rewriting of a physical block corresponding to the logical address is small. This is because, even if such a physical block is not dared to set as a target of the active wear leveling, because a writing request from the host 3 is frequently received, the physical block is forced to be replaced with a spare block.

Therefore, according to this embodiment, it is possible to reduce a necessary number of times of the active wear leveling while maintaining the accuracy of the averaging of the numbers of times of rewriting of physical blocks by the active wear leveling in the past. Consequently, because it is possible to reduce the number of times of physical block erasing involved in voluntary data rewriting of the active wear leveling, the extension of the life of the memory system can expected.

As explained at step S304, when there are a plurality of leisure physical blocks, because of the same reason as explained in the first and second embodiments, it is possible to improve the accuracy of the averaging of the numbers of times of rewriting of the physical blocks by selecting the leisure physical blocks in an opposite order such that data of a leisure physical block having a smaller number of times of logical address writing corresponding thereto among the leisure physical blocks is written in a fatigue spare block having a larger number of times of physical block erasing. In other words, according to this embodiment it is also possible to improve the accuracy of the averaging of the numbers of times of rewriting of the physical blocks by the active wear leveling and further extend the life of the memory system.

Further, this embodiment is improvement of the active wear leveling. The improved active wear leveling can be used together with the improved passive wear leveling explained in the first and second embodiments. A further effect can be expected by using the improved active wear leveling and the improved passive wear leveling together. When a rewriting instruction from the host 3 is received, the memory controller 10 only has to operate according to the flowchart of FIG. 5 or FIG. 12. When a rewriting request from the host 3 is not received, the memory controller 10 only has to operate according to the flowchart of FIG. 13. Consequently, it can be expected that the accuracy of the averaging of the numbers of times of physical block erasing than the first to third embodiments. The extension of the life of the memory system can be further realized.

All the embodiments explained above are based on an idea that, in a storage device that is mounted with a plurality of storage elements having a deterioration characteristic depending on the number of times of physical rewriting and in which a correspondence relation of logical to physical conversion changes every time rewriting is performed, the number of times of writing in a logical address is a prediction value of a frequency of writing in the logical address in future. In other words, the extension of the life of the storage device is realized by daring to allocate a spare block having a large number of times of erasing and a high degree of fatigue to a logical address having a small number of times of writing such that the averaging of the number of times of physical rewriting of the storage elements can be more highly accurately performed in future.

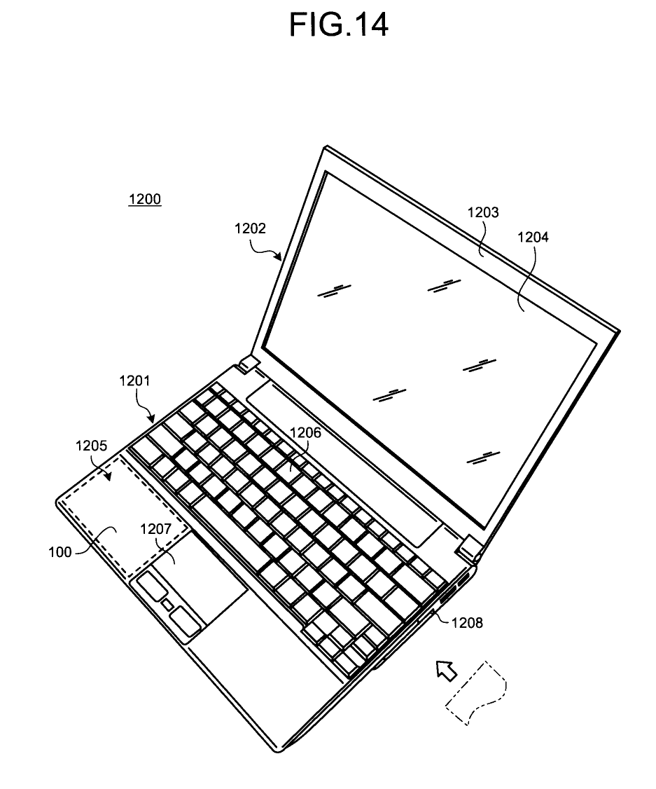

FIG. 14 is a perspective view of an example of a personal computer 1200 mounted with a solid state drive (SSD) 100 according to a fourth embodiment. The SSD 100 is, for example, the memory system explained in the first to third embodiments.

The personal computer 1200 includes a main body 1201 and a display unit 1202. The display unit 1202 includes a display housing 1203 and a display device 1204 housed in the display housing 1203.

The main body 1201 includes a housing 1205, a keyboard 1206, and a touch pad 1207 as a pointing device. A main circuit board, an optical disk device (ODD) unit, a card slot, the SSD 100, and the like are housed on the inside of the housing 1205.

The card slot is provided adjacent to a peripheral wall of the housing 1205. An opening 1208 opposed to the card slot is provided in the peripheral wall. A user can insert an additional device into and remove the additional device from the card slot from the outside of the housing 1205 through the opening 1208.

The SSD 100 can also be used while being mounted on the inside of the personal computer 1200 as a replacement of the HDD in the pastor can also be used as an additional device while being inserted into the card slot included in the personal computer 1200.

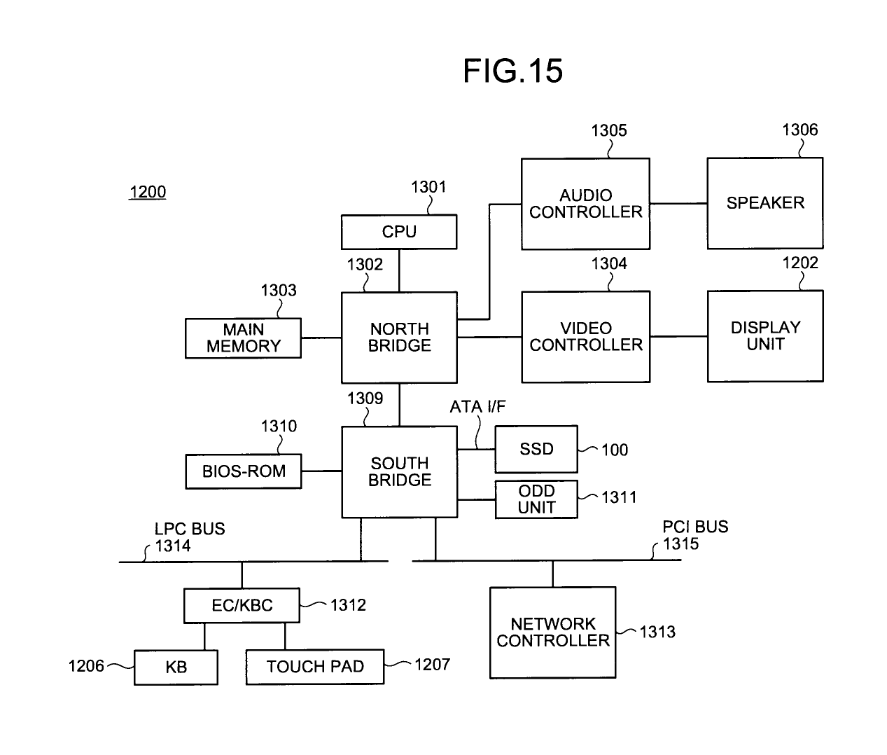

FIG. 15 is a diagram of a system configuration example of the personal computer mounted with the SSD. The personal computer 1200 includes a CPU 1301, a north bridge 1302, a main memory 1303, a video controller 1304, an audio controller 1305, a south bridge 1309, a basic input output system (BIOS)-ROM 1310, the SSD 100, an ODD unit 1311, an embedded controller/keyboard controller integrated circuit (IC) (EC/KBC) 1312, and a network controller 1313.

The CPU 1301 is a processor provided to control the operation of the personal computer 1200. The CPU 1301 executes an operating system (OS) loaded from the SSD 100 to the main memory 1303. When the ODD unit 1311 executes at least one of readout processing and writing processing on an inserted optical disk, the CPU 1301 executes the processing.

The CPU 1301 also executes a basic input output system (BIOS) stored in the BIOS-ROM 1310. The system BIOS is a computer program for controlling hardware in the personal computer 1200.

The north bridge 1302 is a bridge device that connects a local bus of the CPU 1301 and the south bridge 1309. A memory controller that access-controls the main memory 1303 is also incorporated in the north bridge 1302.

The north bridge 1302 also has a function of executing communication with the video controller 1304 and communication with the audio controller 1305 via an accelerated graphics port (AGP) bus or the like.

The main memory 1303 temporarily stores a computer program and data and functions as a work area of the CPU 1301. The main memory 1303 includes, for example, a dynamic random access memory (DRAM).

The video controller 1304 is a video reproduction controller that controls the display unit 1202 used as a display monitor of the personal computer 1200.

The audio controller 1305 is an audio reproduction controller that controls a speaker 1306 of the personal computer 1200.

The south bridge 1309 controls devices on a low pin count (LPC) bus 1314 and devices on a peripheral component interconnect (PCI) bus 1315. The south bridge 1309 controls the SSD 100, which is a storage device that stores various kinds of software and data, via an ATA interface.

The personal computer 1200 accesses the SSD 100 in sector units. A writing command, a readout command, a flash command, and the like are input to the SSD 100 via the ATA interface.

The south bridge 1309 also has a function for access-controlling the BIOS-ROM 1310 and the ODD unit 1311.

The EC/KBC 1312 is a one-chip microcomputer in which an embedded controller for power management and a keyboard controller for controlling the keyboard (KB) 1206 and the touch pad 1207 are integrated.

The EC/KBC 1312 has a function of turning on and off a power supply for the personal computer 1200 according to operation of a power button by the user. The network controller 1313 is a communication device that executes communication with an external network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller that performs control of a nonvolatile semiconductor memory including a plurality of blocks, the block being a unit of data erasing, the memory controller comprising:
a first management table that stores correspondence between logical block addresses and physical block addresses;
a second management table that stores a number of times of data writing for each of the logical block addresses;
a third management table that stores a number of times of data erasing for each of the physical block addresses; and
a writing control unit that selects a spare block not associated with the logical block address and writes data in the spare block, wherein
the writing control unit levels, based on the number of times of data writing associated with the logical block addresses and the number of times of data erasing associated with the physical block addresses, numbers of times of data erasing among the blocks.

2. The memory controller according to claim 1, wherein the writing control unit selects:
in response to a writing request designating a logical block address having a relatively large number of times of data writing in the second management table, a spare block having a relatively small number of times of data erasing in the third management table;
in response to a writing request designating a logical block address having a relatively small number of times of data writing in the second management table, a spare block having a relatively large number of times of data erasing in the third management table.

3. The memory controller according to claim 1, wherein the writing control unit associates, based on the second management table and the third management table, the logical block address and the spare block such that a magnitude relation of the numbers of times of data writing and a magnitude relation of the numbers of times of data erasing are opposite.

4. The memory controller according to claim 1, wherein the writing control unit:
classifies, based on a magnitude relation of the numbers of times of data writing in the second management table, the logical block addresses into a plurality of logical address groups;
classifies, based on a magnitude relation of the numbers of times of data erasing in the third management table, the physical block addresses of the spare blocks into a plurality of spare block groups;
associates the logical address groups and the spare block groups such that the magnitude relation of the number of times of data writing and the magnitude relation of the numbers of times of data erasing are opposite.

5. The memory controller according to claim 4, wherein the writing control unit:
performs the classification of the logical block addresses based on the magnitude relation of the numbers of times of data writing by comparing ratios of the numbers of times of data writing to a maximum of the numbers of times of data writing in the second management table with a threshold; and
performs the classification of the spare blocks based on the magnitude relation of the numbers of times of data erasing by comparing ratios of the numbers of times of data erasing to a maximum of the numbers of times of data erasing in the third management table with a threshold.

6. The memory controller according to claim 1, wherein when no writing request is received, the writing control unit:
detects a logical block address having the number of times of data writing smaller than a first threshold in the second management table;
detects a physical block address, corresponding to the detected logical block address, having the number of times of data erasing smaller than a second threshold in the third management table;
selects a spare block having the number of times of data erasing larger than a third threshold in the third management table; and
writes, in the selected spare block, data stored in the detected physical block address and updates the first management table.

7. The memory controller according to claim 6, wherein the first threshold is a value obtained by multiplying a maximum of the numbers of times of data writing in the second management table with a predetermined constant.

8. A memory system comprising:
a nonvolatile semiconductor memory having a plurality of blocks as units of data erasing; and
a memory controller that performs control for rewriting data of the nonvolatile semiconductor memory, the memory controller including:
a first management table that stores correspondence between logical block addresses as logical addresses in the block units designated by a host and physical block addresses indicating storage locations in the nonvolatile semiconductor memory of the blocks;
a second management table that stores, for each of the logical block addresses, a number of times of writing of data in the nonvolatile semiconductor memory from the host;
a third management table that stores a number of times of data erasing for each of the physical block addresses; and
a writing control unit that selects, in response to a writing request designating a logical address from the host, a spare block as the block not having logical address corresponding thereto and writes data in the spare block, wherein
the memory controller averages, based on the number of times of writing of data stored for each of the logical block addresses and the number of times of data erasing stored for each of the physical block addresses, numbers of times of data erasing among the blocks.

9. The memory system according to claim 8, wherein the writing control unit selects, in response to a writing request designating a logical block address having a relatively large number of times of writing stored in the second management table, a spare block having a relatively small number of erasing stored in the third management table among the spare blocks and selects, in response to a writing request designating a logical block address having a relatively small number of times of writing stored in the second management table, a spare block having a relatively large number of times of erasing stored in the third management table among the spare blocks.

10. The memory system according to claim 8, wherein
the memory controller associates, based on the second management table and the third management table, the logical block addresses and the spare blocks such that a magnitude relation of the numbers of times of writing and a magnitude relation of the numbers of times of erasing are opposite, and
the writing control unit selects, in response to a writing request designating a logical address from the host, a spare block based on the association.

11. The memory system according to claim 8, wherein
the memory controller classifies, based on a magnitude relation of the numbers of times of writing stored in the second management table, the logical block addresses into a plurality of logical address groups, classifies, based on a magnitude relation of the numbers of times of erasing stored in the third management table, the spare blocks into a plurality of spare block groups, and associates the logical address groups and the spare block groups such that the magnitude relation of the number of times of writing and the magnitude relation of the numbers of times of erasing are opposite, and
the writing control unit selects, in response to a writing request designating a logical address from the host, a spare block classified in the spare block group associated with the logical address group in which the logical address is classified.

12. The memory system according to claim 11, wherein the memory controller performs the classification of the logical block addresses based on the magnitude relation of the numbers of times of writing by comparing ratios of the numbers of times of writing to a maximum of the numbers of times of writing stored in the second management table with a threshold and performs the classification of the spare blocks based on the magnitude relation of the numbers of times of erasing by comparing ratios of the numbers of times of erasing to a maximum of the numbers of times of erasing among the spare blocks stored in the third management table with a threshold.

13. The memory system according to claim 8, wherein the writing control unit selects among the spare blocks, when no writing request from the host is received, a fatigue spare block having the number of times of erasing stored in the third management table larger than a third threshold when a condition that the number of times of erasing stored in the third management table of a physical block address corresponding to, in the first management table, a logical block address having the number of times of writing stored in the second management table smaller than a first threshold is smaller than a second threshold is satisfied and writes, in the fatigue spare block, data written in a leisure physical block indicating a physical block address corresponding to a leisure logical address, which is a logical address satisfying the condition, writes a physical block address of the fatigue spare block in the first management table to correspond to the leisure logical address, and erases a physical block address of the leisure physical block to thereby set the leisure physical block as the spare block.

14. The memory system according to claim 13, wherein the first threshold is a value obtained by multiplying a maximum of the numbers of times of writing stored in the second management table with a predetermined constant.

15. A method of controlling a memory system including a nonvolatile semiconductor memory having a plurality of blocks, the block being a unit of data erasing, and a memory controller that performs control of the nonvolatile semiconductor memory, the method comprising the memory controller storing, in a first management table, correspondence between logical block addresses and physical block addresses, storing, in a second management table, a number of times of data writing for each of the logical block addresses, and storing, in a third management table, a number of times of data erasing for each of the physical block addresses, wherein
writing control for selecting a spare block not associated with the logical address and writing data in the spare block includes leveling, based on the number of times of data writing associated with the logical block addresses and the number of times of data erasing associated with the physical block addresses, numbers of times of data erasing among the blocks.

16. The method for controlling a memory system according to claim 15, wherein the writing control includes selecting, in response to a writing request designating a logical block address having a relatively large number of times of data writing in the second management table, a spare block having a relatively small number of times of data erasing in the third management table and selecting, in response to a writing request designating a logical block address having a relatively small number of times of data writing in the second management table, a spare block having a relatively large number of times of data erasing in the third management table.

17. The method for controlling a memory system according to claim 15, wherein the writing control further comprising:
associating, based on the second management table and the third management table, the logical block address and the spare block such that a magnitude relation of the numbers of times of data writing and a magnitude relation of the numbers of times of data erasing are opposite.

18. The method for controlling a memory system according to claim 15, wherein the writing control further comprising classifying, based on a magnitude relation of the numbers of times of data writing in the second management table, the logical block addresses into a plurality of logical address groups, classifying, based on a magnitude relation of the numbers of times of data erasing in the third management table, the physical block addresses of the spare blocks into a plurality of spare block groups, and associating the logical address groups and the spare block groups such that the magnitude relation of the number of times of data writing and the magnitude relation of the numbers of times of data erasing are opposite.

19. The method for controlling a memory system according to claim 18, wherein the writing control further comprising performing the classification of the logical block addresses based on the magnitude relation of the numbers of times of data writing by comparing ratios of the numbers of times of data writing to a maximum of the numbers of times of data writing in the second management table with a threshold and performing the classification of the spare blocks based on the magnitude relation of the numbers of times of data erasing by comparing ratios of the numbers of times of data erasing to a maximum of the numbers of times of data erasing in the third management table with a threshold.

20. The method for controlling a memory system according to claim 15, wherein when no writing request from the host is received, the writing control further comprising:
detecting a logical block address having the number of times of data writing smaller than a first threshold in the second management table;
detecting a physical block address, corresponding to the detected logical block address, having the number of times of data erasing smaller than a second threshold in the third management table;
selecting a spare block having the number of times of data erasing larger than a third threshold in the third management table; and
writing, in the selected spare block, data stored in the detected physical block address and updates the first management table.

21. The method for controlling a memory system according to claim 15, wherein the first threshold is a value obtained by multiplying a maximum of the numbers of times of data writing in the second management table with a predetermined constant.
